(19) United States
(12) Patent Application Publication
(10) Pub. No.: US 2018/0139369 A1
(43) Pub. Date: May 17, 2018

(54) BACKLIT FACE DETECTION

(71) Applicant: Motorola Mobility LLC, Chicago, IL (US)

(72) Inventors: Yin hu Chen, Deerfield, IL (US); Daniel Bloom, Loveland, CO (US); Valeriy Marchevsky, Glenview, IL (US); Susan Yanqing Xu, Westmont, IL (US)

(21) Appl. No.: 15/353,435

(22) Filed: Nov. 16, 2016

(51) Int. Cl. H04N 5/235; H04N 5/225; G06K 9/00

(52) U.S. Cl. CPC H04N 5/2354; G06K 9/00228; H04N 5/2256; H04N 5/2351

(57) ABSTRACT

For backlit face detection, an apparatus includes a main camera and an auxiliary camera that capture image data of photographic subject matter. The main camera and auxiliary camera are located on the same surface of the apparatus. The apparatus further includes a processor that increases an exposure level of the auxiliary camera to expose a dark region in response to the photographic subject matter being a backlit scene. Here settings the main camera are unaffected by increasing the exposure level of the auxiliary camera. The processor also searches for a face within the dark region using auxiliary image data captured with the increased exposure level. Additionally, the processor adjusts an exposure setting of the main camera based on face information received from the auxiliary camera in response to a face being present within the dark region.

### FIELD

The subject matter disclosed herein relates to digital cameras and more particularly relates to automatically detecting a backlit face using a dual- or multi-camera system.

### BACKGROUND

### Description of the Related Art

Face detection under backlit scene is a problem for traditional cameras. Due to the backlight, the face is too dark to detect. Without detecting the face, many exposure adjustment algorithms to make the face properly exposed are useless at this backlit scene. Additionally, it is highly disruptive to adjust exposure on the single camera to search for face, as it will show up on the viewfinder and end user will notice it, so can't adjust exposure to search for face.

### BRIEF SUMMARY

A method for backlit face detection is disclosed. The method includes capturing main image data of a photographic subject matter from a main camera and auxiliary image data of the photographic subject matter from an auxiliary camera. The main camera and auxiliary camera are located on a common device surface. The method also includes increasing an exposure level of the auxiliary camera to expose, in auxiliary image data, a dark region present in the main image data in response to the photographic subject matter being a backlit scene. Here, settings the main camera are unaffected by increasing the exposure level of the auxiliary camera.

The method also includes searching for a face within the dark region using auxiliary image data captured with the increased exposure level. The method further includes adjusting an exposure setting of the main camera based on face information received from the auxiliary camera in response to a face being present within the dark region. Also disclosed are an apparatus and program product which perform the functions of the method.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a drawing illustrating one embodiment of a system for backlit face detection;

FIG. 2 is a schematic block diagram illustrating one embodiment of an apparatus for backlit face detection;

FIG. 3 is a diagram illustrating one embodiment of a backlit scene;

FIG. 4 is a diagram illustrating one embodiment of a procedure for an auxiliary camera to detect a backlit face;

FIG. 5 is a diagram illustrating one embodiment of a procedure for a main camera to present a backlit face;

FIG. 6 is a diagram illustrating an adjusted scene; and

FIG. 7 is a schematic flow chart diagram illustrating one embodiment of method for backlit face detection.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in code and/or software for execution by various types of processors. An identified module of code may, for instance, comprise one or more physical or logical blocks of executable code, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The disclosed embodiments provide systems, apparatuses, methods, and program products for backlit face detection. In a dual- or multi-camera system, different exposures are applied in order to detect backlit face. In general, only one camera that puts its frame to the viewfinder, with the other camera frame being used for image fusion, depth map, etc, while not show up in viewfinder. A first camera (e.g., main camera) uses normal exposure settings and displays a preview at a viewfinder display. A second camera (e.g., auxiliary camera) will dynamically adjust its exposure (e.g., by increasing the exposure time, or by increasing gain, or by increasing both exposure time and gain) to search for a face in a backlit scene. When a face is detected, the two cameras are synchronized in order to properly expose the detected face. The second camera dynamically adjusts exposure and search for faces in the background, so that the user does not notice the face searching procedure with exposure changes.

The apparatus includes a main camera that captures main image data of a photographic subject matter and an auxiliary camera that captures auxiliary image data of the photographic subject matter. The main camera and auxiliary camera are located on a common surface (e.g., the same surface) of the apparatus. The apparatus further includes a processor and a memory that stores code executable by the processor.

The processor increases an exposure level of the auxiliary camera to expose, in the auxiliary image data, a dark region present in the main image data in response to the photographic subject matter being a backlit scene, such that settings the main camera are unaffected by increasing the exposure level of the auxiliary camera. The processor also searches for a face within the dark region using auxiliary image data captured with the increased exposure level. Additionally, the processor adjusts an exposure setting of the main camera based on face information received from the auxiliary camera in response to a face being present within the dark region. In some embodiments, the processor determines, using the main image data or the auxiliary image data, whether the photographic subject matter is backlit scene.

In certain embodiments, increasing an exposure level of the auxiliary camera to expose, in the auxiliary image data, a dark region present in the main image data includes the processor iteratively increases the exposure level by a predetermined amount and searches the auxiliary image data for a face. In such embodiments, the processor again increases the exposure level by a predetermined amount, in response to not detecting a face, and again searches the auxiliary image data for a face until one of: detecting a face, properly exposing the dark region without detecting a face, and reaching a maximum exposure level without detecting a face.

In some embodiments, the apparatus further includes a viewfinder display. In such embodiments, increasing an exposure level of the auxiliary camera includes the processor displaying the main image data on the viewfinder display while concurrently adjusting the exposure level of the auxiliary camera.

In certain embodiments, the face information indicates a face region where a face is detected, the face region having a size and a location, wherein the face region is a subset of the dark region. In one embodiment, the processor further performs an auto-focus routine using one of image data corresponding to the face region, auxiliary image data corresponding to the face region, and statistics data corresponding to the face region. In another embodiment, the processor further performs a skin color rendering routine using one of main image data, auxiliary image data, and statistics data corresponding to the face region. In a further embodiment, the processor additionally performs an automatic white balance routine using one of main image data corresponding to the face region and auxiliary image data corresponding to the face region.

In some embodiments, the processor, in response to a face being present within the dark region, identifies a number of faces present in the dark region, the face information comprising the identified number of faces. In certain embodiments, the processor returns an exposure level of the auxiliary camera to an original value in response to determining that no faces are present in the dark region. In one embodiment, the dark region is an underexposed foreground of the photographic subject matter

In certain embodiments, the processor further synchronizes the face information from the auxiliary camera to the main camera, the face information including a number of faces, a size for each face, and a position of each face. In certain embodiments, the processor further uses a face region for exposure for the main camera and the auxiliary camera, in response to detecting a face.

A method for backlit face detection may include capturing main image data of a photographic subject matter from a main camera and auxiliary image data of the photographic subject matter from an auxiliary camera, the main camera and auxiliary camera being located on a common device surface. The method also includes increasing an exposure level of the auxiliary camera to expose, in auxiliary image data, a dark region present in the main image data in response to the photographic subject matter being a backlit scene. Here, settings the main camera are unaffected by increasing the exposure level of the auxiliary camera. The method also includes searching for a face within the dark region using auxiliary image data captured with the increased exposure level. The method further includes adjusting an exposure setting of the main camera based on face information received from the auxiliary camera in response to a face being present within the dark region.

In some embodiments, increasing an exposure level of the auxiliary camera to expose a dark region in the main image data includes iteratively increasing the exposure level by a predetermined amount and searching the auxiliary image data for a face and again increasing the exposure level by the predetermined amount, in response to not detecting a face, and again searching the auxiliary image data for a face, until one of detecting a face, properly exposing the dark region without detecting a face, and reaching a maximum exposure level without detecting a face.

In certain embodiments, the method for backlit face detection includes synchronizing the face information from the auxiliary camera to the main camera, the face information including a number of faces, a size for each face, and a position of each face. In such embodiments, the method may also include performing an auto-focus routine based on one or more of the main image data corresponding to the position of each face, the auxiliary image data corresponding to the position of each face, and statistics data corresponding to the position of each face. Additionally, the method may include performing an automatic white balance routine using one or more of the main image data corresponding to the position of each face, the auxiliary image data corresponding to the position of each face, and statistics data corresponding to the position of each face.

The program product for backlit face detection includes a computer readable storage medium that stores code executable by processor, the executable code including code to perform: capturing image data of a photographic subject matter from a main camera and from an auxiliary camera, the main camera and auxiliary camera located on a common device surface and increasing an exposure level of an auxiliary camera to expose, in auxiliary image data, a dark region present in the image data in response to the photographic subject matter being a backlit scene. Here, settings the main camera are unaffected by increasing the exposure level of the auxiliary camera. The program product further includes code to perform: searching for a face is present within the dark region using auxiliary image data captured with the increased exposure level and adjusting an exposure setting of the main camera based on face information received from the auxiliary camera in response to a face being detected within the dark region.

In certain embodiments, increasing an exposure level of the auxiliary camera comprises displaying the image data captured by the main camera on a viewfinder display while concurrently adjusting the exposure level of the auxiliary camera. In some embodiments, the face information includes a location of the detected face and the program product further includes code to perform one of an auto-focus routine and a color correction routine based one or more of image data corresponding to a position of each detected face captured by the main camera, image data corresponding to a position of each detected face captured by the auxiliary data, and statistics data corresponding to a position of each the detected face.

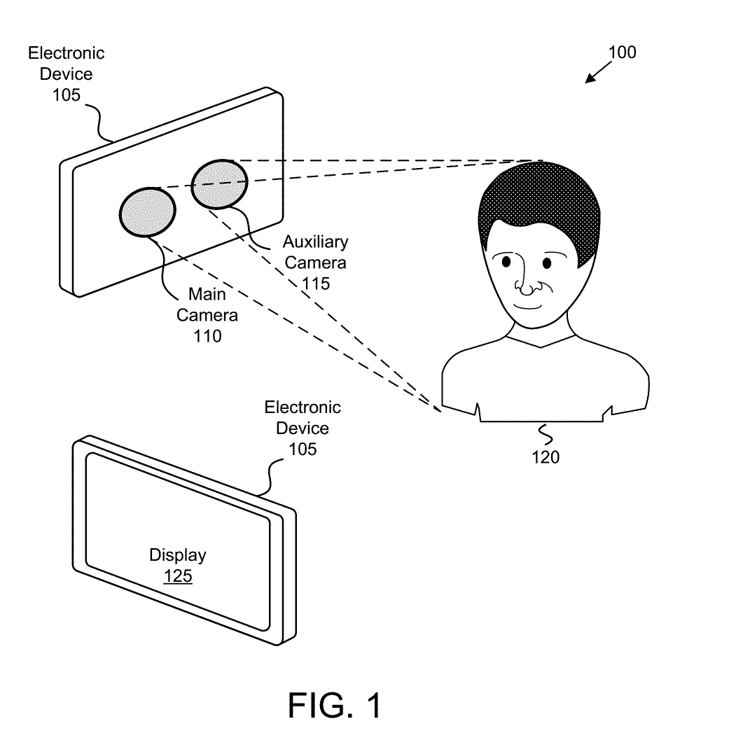

FIG. 1 is a schematic block diagram illustrating one embodiment of a system 100 for backlit face detection, according to embodiments of the disclosure. In the depicted embodiment, the system 100 includes an electronic device 105 having multiple cameras. The electronic device 105 includes at least a main camera 110 and an auxiliary camera 115. The main camera 110 and the auxiliary camera 115 are located on a common face (e.g., the same surface) of the electronic device 105 and point to the same photographic subject matter 120. As used herein, the term “photographic subject matter” refers to the scene, objects, persons, scenery, landscape, or other content to be photographed. Additionally, the electronic device 105 may include additional cameras (not shown).

Examples of electronic devices 105 include, but are not limited to, a mobile telephone, a tablet computer, laptop computer, a camera, a portable gaming system, a portable entertainment system, or other device having multiple cameras. The electronic device 105 captures image data of the photographic subject matter 120 using the multiple cameras. Image data captured by the main camera 110 is referred to herein as “main image data.” Image data captured by the auxiliary camera 115 is referred to herein as “auxiliary image data.” Because the main camera 110 and auxiliary camera 115 are located on the same face of the electronic device 105 and pointed in the same direction, both the main camera 110 and the auxiliary camera 115 capture image data of the same photographic subject matter 120.

In certain embodiments, the electronic device 105 includes a display 125. The display 125 may be used as a viewfinder so that a user of the electronic device 105 can see the image data captured by the main camera 110. The electronic device 105 adjusts exposure levels of the auxiliary camera 115 and searches for faces within the resulting auxiliary image data. If a face is detected, the auxiliary camera 115 compiles face information and electronic device 105 synchronizes the face information with the main camera 110. At this point, and exposure level of the main camera 110 is adjusted based on the face information and adjusted main image data is presented on the display 125.

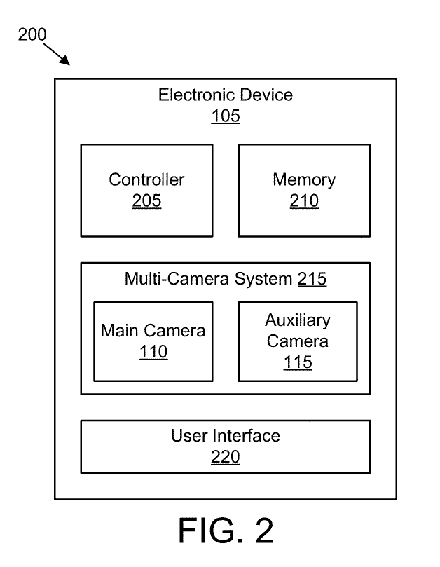

FIG. 2 is a schematic block diagram of an apparatus 200 for backlit face detection, according to embodiments of the disclosure. The apparatus 200 may be one embodiment of the electronic device 105 discussed above with reference to FIG. 1. In addition, the electronic device 105 includes a controller 205, a memory 210, a multi-camera system 215, and a user interface 220. The multi-camera system 215 comprises at least two cameras and includes the main camera 110 and the auxiliary camera 115.

The controller 205, in one embodiment, may include any known controller capable of executing computer-readable instructions and/or capable of performing logical operations. For example, the controller 205 may be a microcontroller, a microprocessor, a central processing unit (“CPU”), a graphics processing unit (“GPU”), an auxiliary processing unit, a field programmable gate array (“FPGA”), or similar programmable controller. In certain embodiments, the controller 205 is a processor coupled to the main camera 110 and the auxiliary camera 115. In some embodiments, the controller 205 executes instructions stored in the memory 210 to perform the methods and routines described herein. The controller 205 is communicatively coupled to the memory 210, the multi-camera system 215, and the user interface 220.

The controller 205 controls the multi-camera system 215 to capture image data of the photographic subject matter 120. In a first embodiment, both the main camera 110 and the auxiliary camera 115 capture image data using an initial exposure setting. In certain embodiments, the initial exposure setting is the same for both the main camera 110 and the auxiliary camera 115. For example, the main camera 110 and the auxiliary camera 115 may be substantially identical cameras (e.g., having substantially identical lenses, image sensors, etc.) and thus use the same initial exposure setting. The initial exposure setting may be derived using an automatic exposure routine. In other embodiments, the main camera 110 and the auxiliary camera 115 may have different properties (e.g., having different lenses, image sensors, etc.), thus requiring a different initial exposure setting for the main camera 110 than used by the auxiliary camera 115.

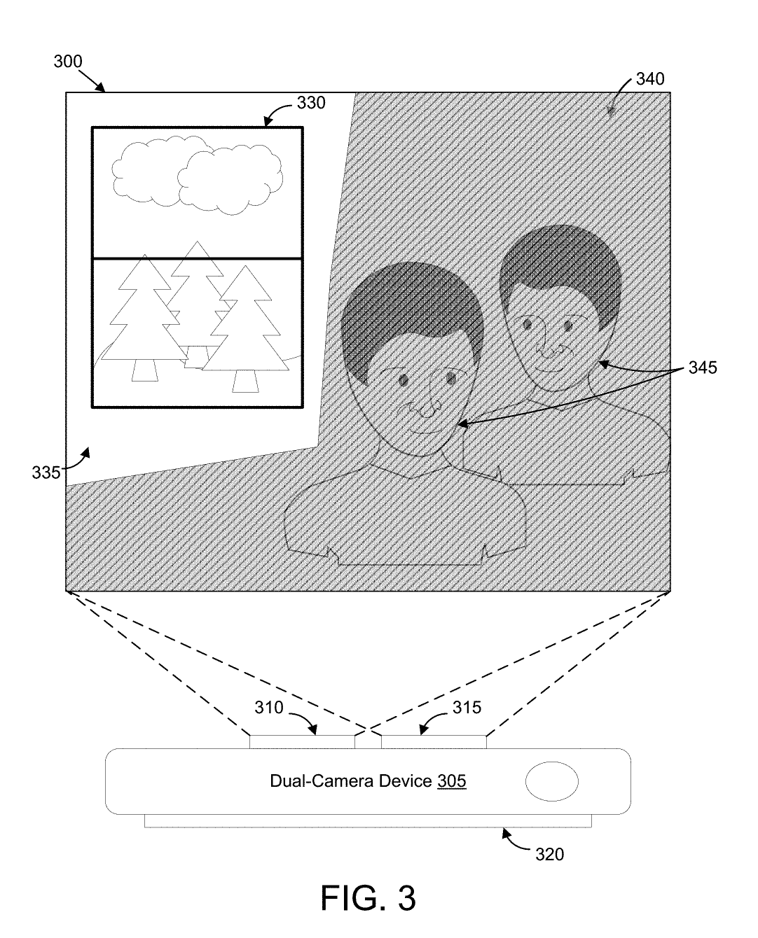

The controller 205 further determines whether the photographic subject matter is a backlit scene. As used herein, a backlit scene refers to any situation where the light source is in the background thereby causing one or more dark regions in the foreground. Accordingly, a backlit scene may be characterized by an overexposed background and/or an underexposed foreground. The difficulty arises in detecting faces within the dark (e.g., underexposed) regions of the foreground as the automatic exposure routines do not expose the foreground with sufficient clarity for a face-detecting algorithm to detect a face present in the dark foreground regions. This situation is illustrated in FIG. 3, discussed in further detail below.

In certain embodiments, the controller 205 determines whether the photographic subject matter is a backlit scene by examining image data from the main camera 110, referred to as “main image data.” In other embodiments, the controller 205 determines whether the photographic subject matter is a backlit scene by examining image data from the auxiliary camera 115, referred to as “auxiliary image data.” In response to determining that the photographic subject matter is of a backlit scene, the controller 205 adjusts one more camera settings of the auxiliary camera 115 relating to exposure level.

Accordingly, the controller 205 increases an exposure level in the auxiliary camera 115, when the photographic subject matter is a backlit scene, to expose a dark region present in the unadjusted auxiliary image data. The controller 205 adjusts the auxiliary camera 115 without adjusting settings of the main camera 110, although settings of the main camera 110 may be adjusted for other reasons. In increasing the exposure level of the auxiliary camera 115, the controller 205 exposes in the auxiliary image data one or more dark regions present in the main image data. Note that adjusting the auxiliary camera 115 occurs in the background without adjusted images being displayed on the display 125 (viewfinder).

In response to increasing the exposure level in the auxiliary camera 115, the controller 205 initiates a search for face within the dark region (e.g., using auxiliary image data captured with the setting(s) adjusted for increased exposure level). In one embodiment, the controller 205 itself performs a face-detection algorithm operating on the auxiliary image data. In another embodiment, the controller 205 signals the auxiliary camera 115 to perform the face detection algorithm (e.g., using an image processor of the auxiliary camera 115). In certain embodiments, face detection algorithm is limited to operating only on the originally dark region(s) that are now exposed due to the increased exposure level of the auxiliary camera 115. Note that the main camera 110 continues to capture main image data which may be presented to the user via the display 125 while exposure level of the auxiliary camera is adjusted in the background.

In one embodiment, the controller 205 incrementally increases the exposure level the auxiliary camera 115 (e.g., by one level) and initiates the face detection routine. If a face is detected, then face information is gathered as described below. Otherwise, if no face is detected, the controller 205 again increases the exposure level of the auxiliary camera 115 by another increment (level) and again initiates the face detection routine. The controller 205 continues to again increase the exposure level and again search for a face until detecting a face, until the dark region(s) become properly exposed and no face is detected, or until a maximum exposure level is reached (e.g., a maximum gain and/or maximum exposure time) and no face is detected. At this point, if no faces are detected, then the controller 205 concludes that no faces are present within the originally dark region(s). In certain embodiments, the controller 205 causes the auxiliary camera 115 to revert to its original exposure level (e.g., revert to original camera settings) in response to not detecting a face within the originally dark region(s) upon properly exposing the dark region(s) or reaching the maximum exposure level.

In another embodiment, the controller 205 initially increases the exposure level in the auxiliary camera 115 to a maximum level (e.g., a maximum gain and/or maximum exposure time) and initiates the face detection routine. If a face is detected, then face information is gathered as described below. Otherwise, if no face is detected, the controller decreases the exposure level of the auxiliary camera 115 by one increment (level) and again initiates the face detection routine. The controller 205 continues to incrementally decrease the exposure level and again search for a face until detecting a face, until the dark region(s) become properly exposed and no face is detected, or until the original exposure level is reached and no face is detected. At this point, if no faces are detected, then the controller 205 concludes that no faces are present within the dark region.

As used herein, “properly exposing” a region of the image refers to achieving a balanced exposure that minimizes the number of over- and under-exposed pixels in the frame. As understood in the art, an over-exposed region is one that is too light/bright such that detail within the region becomes lost, while an under-exposed region is one that is too dark, such that detail within the region becomes lost. When determining whether the dark region is properly exposed, only the pixels within the dark region are considered (e.g., all other pixels in the image are ignored).

In response to detecting a face within the originally dark region(s) that are now exposed, the controller 205 queries the auxiliary camera 115 for face information. As used herein, the face information refers to data describing a face, features of the face, locations of the face, and the like for the face within the originally dark region(s). Face information may include, but is not limited to, a face region having a size and location surrounding a discovered face, a number faces present, positions (e.g., locations within the image data) of detected faces, a size for each detected face, and the like. In certain embodiments, the face information also includes exposure levels used when the face was detected.

The controller 205 synchronizes the face information with the main camera 110. In response to receiving the face information, the main camera 110 is able to adjust its settings to properly expose the detected faces, to focus on the detected faces, to perform the correction routines such as skin color rendering and automatic white balance (“AWB”), and the like. For example, the main camera 110 may use image data corresponding to the position of each detected face and/or statistics data corresponding to the position of each face to perform auto-focus, skin color rendering, and/or AWB.

The auxiliary camera 115 may additionally adjust its exposure level after detecting a face so as to optimize exposure of the detected face(s) (e.g., achieve a balance that minimizes the number of over- and under-exposed pixels in the region(s) of the detected face(s)). Additionally, the auxiliary camera 115 may perform skin rendering, AWB, autofocus, and the like after generating the face information. Here, the auxiliary camera 115 may use image data corresponding to the position of each detected face and/or statistics data corresponding to the position of each face to perform auto-focus, skin color rendering, and/or AWB.

Here, the image data used may include frames in RGB, YUV, YCbCr, or other suitable colorspace, or frame subsets corresponding to a region surrounding the position of each face. The image data may include raw data captured by an image sensor in the camera (e.g., the main camera 110) and/or data processed by an image signal processor (“ISP”), or other suitable digital signal processor (“DSP”), in the camera.

Additionally, the statistics data used refers to statistics generated from analysis of the image data. Examples of statistics data include, but are not limited to, average pixel values, average deviation of pixel values, maximum/minimum pixel values, or the histogram for an image (or a part thereof). Some statistics data are generated by the image sensor, while other statistics data comes from the ISP. Different types of image sensor generally generate different types of statistics data. Different algorithms may operate using image data, statistics data, or a combination of image data and statistics data. For example, where Bayer filters are used, algorithms to determine proper exposure and auto-white balance may use Bayer grid statistics, while an autofocus algorithm may use Bayer focus statistics.

The memory 210, in one embodiment, is a computer readable storage medium. In some embodiments, the memory 210 includes volatile computer storage media. For example, the memory 210 may include a RAM, including dynamic RAM (“DRAM”), synchronous dynamic RAM (“SDRAM”), and/or static RAM (“SRAM”). In some embodiments, the memory 210 includes non-volatile computer storage media. For example, the memory 210 may include a hard disk drive, a flash memory, or any other suitable non-volatile computer storage device. In some embodiments, the memory 210 includes both volatile and non-volatile computer storage media. In some embodiments, the memory 210 stores data relating to backlit face detection, such as face information, exposure settings, and the like. In some embodiments, the memory 210 also stores program code and related data, such as an operating system or other controller algorithms operating on the electronic device 105.

The multi-camera system 215 includes the main camera 110 and the auxiliary camera 115. In certain embodiments, the multi-camera system 215 may include one or more additional cameras, such as a front facing camera. The multi-camera system 215 may include any number of lenses, image sensors, shutters, and the like.

Each of the main camera 110 and the auxiliary camera 115 may be separate cameras within the multi-camera system 215. For example, the main camera 110 may be capable of adjusting its focus, exposure settings, color settings, camera mode, and other camera settings independently of the auxiliary camera 115. Likewise, the main camera 110 is capable of capturing image data, rendering skin color, adjusting color balance, performing automatic white balance routines, and the like independently of the auxiliary camera 115. Additionally, the auxiliary camera 115 is able to adjust these same settings independently of the main camera 110.

In certain embodiments, the multi-camera system 215 includes two identical cameras one being designated as the “main camera” or as the “auxiliary camera,” with the roles of each camera being interchangeable. The camera designated as the main camera 110 captures image data to be presented on the display 125 (e.g., viewfinder) while the camera designated as the auxiliary camera 115 detects faces in backlit scenes, as described herein. However, in other embodiments, the main camera 110 may not be interchangeable with the auxiliary camera 115.

In certain embodiments, the multi-camera system 215 includes one or more processors (e.g., image processors) for performing image processing, such as color processing, brightness/contrast processing, noise reduction, image stabilization, image sharpening, HDR processing, and the like. In one embodiment, the processors of the multi-camera system 215 may be controlled by, but independent of, the controller 205. In one example, the controller 205 may facilitate communication between an image processor the main camera 110 and an image processor of the auxiliary camera 115.

The user interface 220, in one embodiment, includes the display 125 which may be used as a viewfinder. The user interface 220 may also include any known computer input device including a touch panel, a button, a keyboard, a stylus, a microphone, or the like. For example, the user interface 220 may include a shutter button, a camera mode selector, a menu navigation device, and the like. In some embodiments, the user interface 220 may include a touchscreen or similar touch-sensitive display. In such embodiments, a user may navigate menus, select camera modes, trigger the camera shutter, adjust camera settings, and the like using the touchscreen user interface 220. In some embodiments, the user interface 220 includes two or more different input devices, such as a touch panel and a button, dial, selector, etc.

In certain embodiments, the user interface 220 is capable of outputting audible and/or haptic signals. For example, the user interface 220 may include one or more speakers for producing an audible alert or notification (e.g., a beep or chime) or other sound. In some embodiments, the user interface 220 includes one or more haptic devices for producing vibrations, motion, or other haptic feedback. In some embodiments, all or portions of the user interface 220 may be integrated with the display 125. For example, the user interface 220 and display 125 may form a touchscreen or similar touch-sensitive display. In other embodiments, the user interface 220 comprise additional hardware devices located near the display 125.

FIG. 3 depicts a backlit scene 300, according to embodiments of the disclosure. The backlit scene 300 is captured by a dual-camera device 305. The dual-camera device 305 may be one embodiment of the electronic device 105 described above with reference to FIGS. 1-2. The dual-camera device 305 includes a main camera 310 and an auxiliary camera 315. The main camera 310 and auxiliary camera 315 may be embodiments of the main camera 110 and auxiliary camera 115, respectively, described above with reference to FIGS. 1-2. The dual-camera device 305 also includes a viewfinder 320, which may be one embodiment of the display 125 described above with reference to FIGS. 1-2.

The backlit scene 300 is captured by the main camera 310 and auxiliary camera 315. The main camera 310 captures “main image data” corresponding to the backlit scene 300 while the auxiliary camera 315 captures “auxiliary image data” corresponding to the backlit scene 300. The backlit scene 300 includes a background light source 330 and a light region 335, also in the background. Due to the background light source 330, the backlit scene 300 includes at least one dark region 340. Within the dark region 340 may be at least one face 345 corresponding to an individual in the foreground. The background light source 330 causes the main camera 310 on the auxiliary camera 315 to set an initial exposure level which causes the dark region 340 and obscures the face 345 of the individual in the foreground.

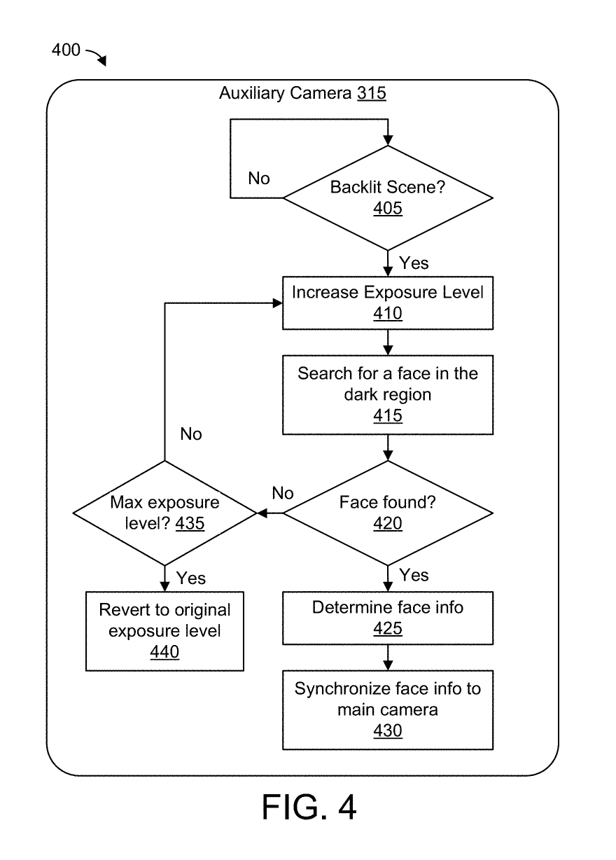

FIG. 4 depicts a procedure 400 for an auxiliary camera (e.g., auxiliary camera 315) to detect a backlit face, according to embodiments of the disclosure. The backlit face may be the face 345 within the dark region 340 of the backlit scene 300, described above. The procedure 400 may be performed by the controller 205 and/or the auxiliary camera 315.

Initially, it is determined 405 whether the photographic subject matter is a backlit scene. In one embodiment, the auxiliary camera 315 continually searches to search for a backlit scene until one is detected. In another embodiment, the auxiliary camera 315 terminates the procedure 400 if no backlit scene is detected.

In response to detecting a backlit scene, the auxiliary camera 315 (or optionally the controller 205) adjusts 410 one or more camera settings of the auxiliary camera 315 in order to increase an exposure level by a first amount. In one embodiment, the first amount may be a minimum step/increment above the initial exposure level. In another embodiment, the first amount may be a larger step above the initial exposure level. For example, the exposure level may be adjusted to a level in between the initial exposure level and a maximum possible exposure level.

After increasing the exposure level, a search is initiated 415 for a face within the dark regions 340 of the backlit scene 300 (e.g., by performing a face detection routine). The one or more dark regions 340 may be identified before the exposure level increased. In one embodiment, the controller 205 searches for faces within auxiliary image data received using the adjusted exposure level setting(s). In another embodiment, an image processor of the auxiliary camera 115 searches for faces within the adjusted auxiliary image data. In certain embodiments, only the dark region(s) 340 are searched (e.g., ignoring the light region 335).

The auxiliary camera 315 determines 420 whether a face is found. If a face is found within the dark region 340, the auxiliary camera 315 determines 425 face information, as described above. The face information is then synchronized 430 to the main camera 310. Otherwise, if no face is found, it is determined 435 whether the exposure level is at a maximum or whether the dark regions 340 are properly exposed. If exposure level is at a maximum or if the dark regions 340 are properly exposed, the auxiliary camera 315 reverts 440 to its original exposure settings in the procedure 400 ends. Otherwise, the exposure level is again increased 410 (e.g., incremented) and the dark regions 340 are again searched for face.

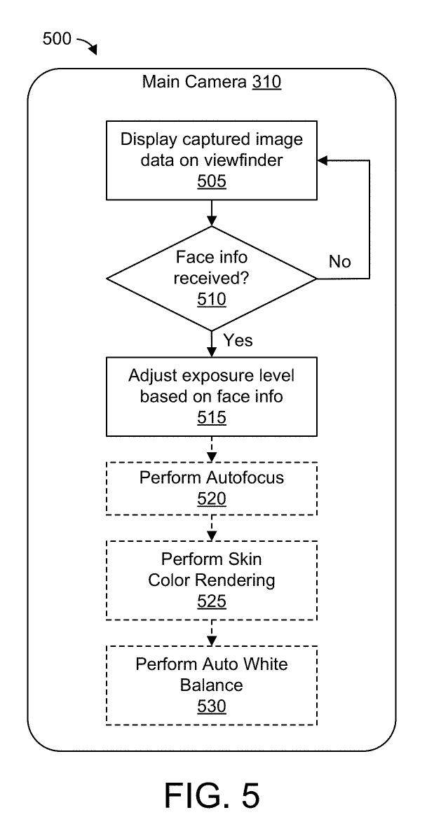

FIG. 5 depicts a procedure 500 for a main camera (e.g., the main camera 310) to display a backlit face, according to embodiments of the disclosure. The backlit face may be the face 345 in the dark region 340, described above. As discussed above with reference to FIG. 4, the auxiliary camera 315 detects the backlit face and synchronizes face information to the main camera 310.

Initially, the main camera 310 displays 505 image data captured using initial exposure settings. The captured image data is displayed 505 on the viewfinder 320. As discussed above, the auxiliary camera 315 searches for faces in the background without displaying image data on the viewfinder 320. Rather, the main camera 310 displays captured image data on the viewfinder 320 while the auxiliary camera 315 simultaneously searches for backlit faces.

At 510, it is determined whether the main camera 310 has received face information. As described above, facial information may include, but is not limited to, a size and position of a face region (the face region encompassing a detected face), a number face is detected, locations of faces detected, and the like. The face information further includes an exposure level (e.g., information regarding an exposure time, gain level, ISO setting, aperture setting, shutter speed, or other relevant camera settings) used to detect faces within the backlit scene 300.

The main camera 310 then adjusts 515 its own exposure level based on the receipt face information. In doing so, the main camera 310 displays adjusted image data on the viewfinder 320, thus presenting the detected faces to the user. In one embodiment, the main camera 310 uses the exposure level received with the face information. In another embodiment, the main camera 310 selects an optimal exposure level based on the receive information.

Optionally, the main camera 310 may perform 520 an autofocus routine using the face information. For example, the main camera 310 may perform the autofocus routine on a location of a detected face (e.g., included in the face information). Additionally, the main camera 310 may perform 525 a skin color rendering routine using image data (or statistics data) corresponding to the location of the face and perform 530 an automatic white balance routine in response to skin color rendering routine using image data corresponding to the location of the face. Results of the autofocus routine, skin color rendering routine, and automatic white balance routine may be displayed on the viewfinder 320.

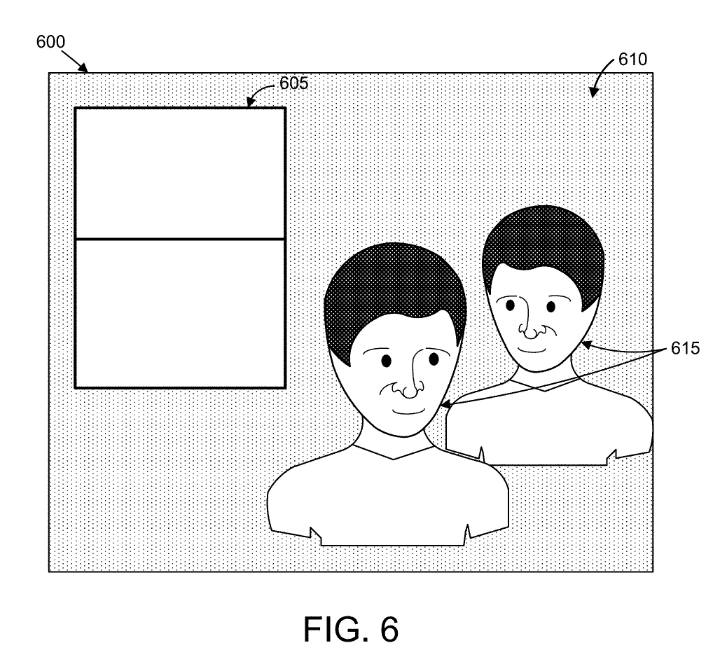

FIG. 6 depicts an adjusted scene 600, according to embodiments of the disclosure. The adjusted scene 600 corresponds to the backlit scene 300 after the auxiliary camera 315 performs backlit face detection (e.g., according to the procedure 400 of FIG. 4) and the main camera 310 adjustments exposure based on synchronized face information (e.g., according to the procedure 500 of FIG. 5). The adjusted scene 600 may correspond to image data captured by the main camera 310.

The adjusted scene 600 includes an overexposed background 605 at a properly exposed foreground 610. Within the foreground 610 are detected faces 615 corresponding to individuals within the foreground. Note that in the backlit scene 300 the faces 345 are underexposed while in the adjusted scene 600 the corresponding faces 615 are visible and properly exposed.

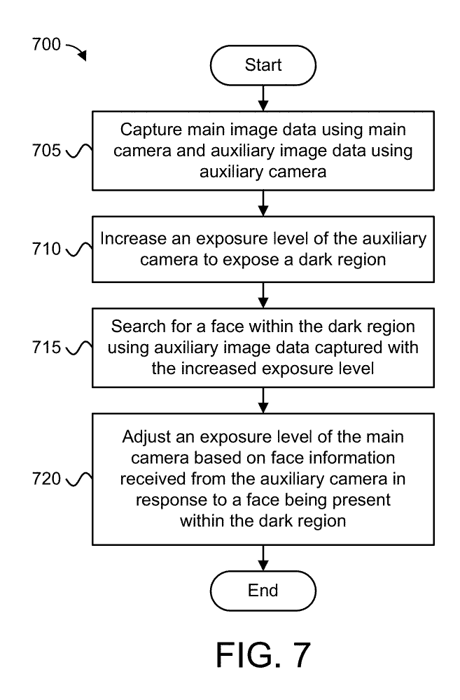

FIG. 7 illustrates a method 700 for backlit face detection, according to embodiments of the disclosure. The method 700 performs back face detection by adjusting an exposure level for an auxiliary camera and searching for faces within a previously underexposed region. In some embodiments, the method 700 may be performed by the electronic device 105. In addition, the method 700 may be performed by a processor (e.g., the controller 205) and/or other semiconductor hardware embodied in the electronic device 105. In another example, the method 700 may be embodied as computer program code stored on computer readable storage media.

The method 700 begins and captures 705 main image data of photographic subject matter using a main camera 110 and auxiliary image data of the photographic subject matter using an auxiliary camera 115. Here, the main camera 110 and auxiliary camera 115 are located on a common device surface. For example, the main camera 110 and the auxiliary camera 115 may be located on the back face of a smartphone, or another handheld device.

The method 700 increases 710 an exposure level of the auxiliary camera 115 to expose, in the auxiliary image data, a dark region present in the main image data (e.g., an underexposed region) in response to the photographic subject matter being a backlit scene. The backlit scene they be detected by analyzing the main image data and/or the auxiliary image data. For example, the backlit scene may include a background light source and/or an underexposed foreground.

Here, the settings of the main camera 110 are unaffected by increasing the exposure level of the auxiliary camera 115. In some embodiments, increasing 710 an exposure level of the auxiliary camera 115 to expose a dark region present in the main image data includes incrementally increasing the exposure level of the auxiliary camera 115. In other embodiments, increasing 710 exposure level of the auxiliary camera 115 includes first increasing the exposure level to an amount midway between the initial exposure level and a maximum exposure level.

The method 700 further searches 715 for a face within a dark region using auxiliary image data captured with the increased exposure level. In one embodiment, searching 715 for a face includes performing a face detection routine on one or more underexposed areas in the originally captured image data. In certain embodiments, searching 715 for a face includes iteratively increasing exposure level by a predetermined amount and again searching the auxiliary image data for a face until a face is detected, until a maximum exposure level is reached without detecting a face, or until the underexposed areas become properly exposed without detecting a face.

The method 700 then adjusts 720 an exposure level of the main camera based on face information received from the auxiliary camera, in response to face being present within the dark region. The method 700 ends. In some embodiments, adjusting 720 exposure settings of the main camera based on face information include synchronizing the face information from the auxiliary camera 115 to the main camera 110. Here, the face information may include a number faces, a size for each face, and a position of each face.

In certain embodiments, the face information may indicate a face region having a size and location, the face region being an area surrounding a detected face. Adjusting 720 the exposure setting of the main camera may also include performing an autofocus routine based on the position of each detected face (e.g., performed on the face region) and/or performing an automatic white balance routine using image data within the face region (e.g., image data corresponding to the position of each detected face).

Embodiments may be practiced in other specific forms. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed is:

1. An apparatus comprising:
a main camera that captures main image data of a photographic subject matter;
an auxiliary camera that captures auxiliary image data of the photographic subject matter, the main camera and auxiliary camera located on the same surface of the apparatus;
a processor;
a memory that stores code executable by the processor to:
increase an exposure level of the auxiliary camera to expose, in the auxiliary image data, a dark region present in the main image data in response to the photographic subject matter being a backlit scene,
wherein settings the main camera are unaffected by increasing the exposure level of the auxiliary camera;
search for a face within the dark region using auxiliary image data captured with the increased exposure level; and
adjust an exposure setting of the main camera based on face information received from the auxiliary camera in response to a face being present within the dark region.

2. The apparatus of claim 1, wherein increasing an exposure level of the auxiliary camera to expose, in the auxiliary image data, a dark region present in the main image data comprises the processor iteratively increasing the exposure level by a predetermined amount and searching the auxiliary image data for a face, wherein the processor, in response to not detecting a face, again increases the exposure level by a predetermined amount and again searches the auxiliary image data for a face until one of: detecting a face, properly exposing the dark region without detecting a face, and reaching a maximum exposure level without detecting a face.

3. The apparatus of claim 1, further comprising a viewfinder display, wherein increasing an exposure level of the auxiliary camera comprises the processor displaying the main image data on the viewfinder display while concurrently adjusting the exposure level of the auxiliary camera.

4. The apparatus of claim 1, wherein the face information indicates a face region where a face is detected, the face region having a size and a location, wherein the face region is a subset of the dark region.

5. The apparatus of claim 4, wherein the processor further performs an auto-focus routine using one of image data corresponding to the face region, auxiliary image data corresponding to the face region, and statistics data corresponding to the face region.

6. The apparatus of claim 4, wherein the processor further performs a skin color rendering routine using one of main image data, auxiliary image data, and statistics data corresponding to the face region.

7. The apparatus of claim 6, wherein the processor further performs an automatic white balance routine using one of main image data corresponding to the face region and auxiliary image data corresponding to the face region.

8. The apparatus of claim 1, wherein the processor, in response to a face being present within the dark region, identifies a number of faces present in the dark region, the face information comprising the identified number of faces.

9. The apparatus of claim 1, wherein the processor returns an exposure level of the auxiliary camera to an original value in response to determining that no faces are present in the dark region.

10. The apparatus of claim 1, wherein the dark region is an underexposed foreground of the photographic subject matter.

11. The apparatus of claim 1, wherein the processor further synchronizes the face information from the auxiliary camera to the main camera, the face information including a number of faces, a size for each face, and a position of each face.

12. The apparatus of claim 1, wherein the processor further uses a face region for exposure for the main camera and the auxiliary camera, in response to detecting a face.

13. A method comprising:
capturing main image data of a photographic subject matter from a main camera and auxiliary image data of the photographic subject matter from an auxiliary camera, the main camera and auxiliary camera being located on a common device surface;
increasing an exposure level of the auxiliary camera to expose, in auxiliary image data, a dark region present in the main image data in response to the photographic subject matter being a backlit scene,
wherein settings the main camera are unaffected by increasing the exposure level of the auxiliary camera;
searching for a face within the dark region using auxiliary image data captured with the increased exposure level; and
adjusting an exposure setting of the main camera based on face information received from the auxiliary camera in response to a face being present within the dark region.

14. The method of claim 13, wherein increasing an exposure level of the auxiliary camera to expose a dark region in the main image data comprises:
iteratively increasing the exposure level by a predetermined amount and searching the auxiliary image data for a face, and
again increasing the exposure level by the predetermined amount, in response to not detecting a face, and again searching the auxiliary image data for a face, until one of detecting a face, properly exposing the dark region without detecting a face, and reaching a maximum exposure level without detecting a face.

15. The method of claim 13, further comprising synchronizing the face information from the auxiliary camera to the main camera, the face information including a number of faces, a size for each face, and a position of each face.

16. The method of claim 15, further comprising performing an auto-focus routine based on one or more of the main image data corresponding to the position of each face, the auxiliary image data corresponding to the position of each face, and statistics data corresponding to the position of each face.

17. The method of claim 15, further comprising performing an automatic white balance routine using one or more of the main image data corresponding to the position of each face, the auxiliary image data corresponding to the position of each face, and statistics data corresponding to the position of each face.

18. A program product comprising a computer readable storage medium that stores code executable by a processor, the executable code comprising code to perform:
capturing image data of a photographic subject matter from a main camera and from an auxiliary camera, the main camera and auxiliary camera located on a common device surface;
increasing an exposure level of an auxiliary camera to expose, in auxiliary image data, a dark region present in the image data in response to the photographic subject matter being a backlit scene,
wherein settings the main camera are unaffected by increasing the exposure level of the auxiliary camera;
searching for a face is present within the dark region using auxiliary image data captured with the increased exposure level; and
adjusting an exposure setting of the main camera based on face information received from the auxiliary camera in response to a face being detected within the dark region.

19. The program product of claim 18, wherein increasing an exposure level of the auxiliary camera comprises displaying the image data captured by the main camera on a viewfinder display while concurrently adjusting the exposure level of the auxiliary camera.

20. The program product of claim 18, wherein the face information includes a location of the detected face, the program product further comprising code to perform one of an auto-focus routine and a color correction routine based on one or more of image data corresponding to a position of each detected face captured by the main camera, image data corresponding to a position of each detected face captured by the auxiliary data, and statistics data corresponding to a position of each detected face.
